(19) United States
(12) Patent Application Publication
(10) Pub. No.: US 2006/0225324 A1
(43) Pub. Date: Oct. 12, 2006

(54) Variable display device

(76) Inventor: Kelly Culiver, (US)

Correspondence Address: Gary K. Price, Esq.;Bowers Harrison, LLP, 25 N.W. Riverside Drive, P.O. Box 1287, Evansville, IN, 47706-1287, US

(21) Appl. No.: 11/385,386

(22) Filed: Mar. 21, 2006

Related U.S. Application Data
(60) Provisional application No. 60/664,056, filed on Mar. 21, 2005.

(51) Int. Cl. G09F 11/02

(52) U.S. Cl. 40/493

(57) ABSTRACT

A variable display device for selectively displaying messages on or adjacent doors to hospital rooms, hotel and motel rooms, offices, conference rooms and the like to communicate such messages to the viewer. The device includes a frame member that is rotatably coupled to a display member movable to change the message appearing in a window of the frame member. In particular, the display member comprises a rotatable disk mounted to a shaft or stud adapted to pivot about an axis. Various display elements are carried on the face of the disk. The display elements take the form of messages to be viewed individually through the window. A knob is preferably mounted at the outermost end of the shaft of stud, adjacent the outer surface of the front panel. Rotating the knob rotates the disk and therefore changes the display element viewed through the window.

### CROSS REFERENCES TO RELATED APPLICATIONS

U.S. Provisional Application for Patent No. 60/664,056, filed Mar. 21, 2005, with title “Variable Display Device” which is hereby incorporated by reference. Applicant claims priority pursuant to 35 U.S.C. par. 119(e)(i).

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

1. Field of the Invention

This present invention relates generally to a device for selectively displaying messages, and it particularly concerns such a device that accomplishes this without electronic components or magnetic couplings.

2. Background Information

Signs are often used on or adjacent doors to hospital rooms, hotel and motel rooms, offices, conference rooms and the like to communicate such messages as “Do Not Disturb,” “Sleeping,” “In Conference,” “Occupied,” etc. This is done in some cases with a door mountable device to selectively display a preferred message. However, existing devices for this purpose suffer from certain drawbacks that need to be overcome. They may, for example, employ relatively complicated and costly mechanical structure, require a hole through the door, and involve inconvenient installation and deinstallation procedures.

Thus, it is desirable to have a new and improved device for this purpose—one that does not require electronic components and is less complicated and costly and more convenient to install and deinstalll without the need for a hole through the door.

Accordingly, there is a need for an improved display device that selectively displays messages. The present invention meets this need.

### SUMMARY OF THE INVENTION

The present invention solves the problems outlined above without the application of electronic components or magnetic coupling as is readily apparent in the prior art. A variable display device is provided that generally includes a frame member that is mounted on a surface. The frame member is coupled to a display member that is movable to change the message appearing in a window of the frame member.

The components of the present invention are easily fabricated; they are less complicated and less costly; and they can be attached onto the door or surface for mounting ease.

The variable display device constructed according to the present invention includes the frame member with the window. Behind the window is a display member coupled to the frame member. The display member is movable to change the message appearing in the window. In particular, the display member comprises a rotatable disk mounted to a shaft or stud adapted to pivot about an axis. Various display elements are carried on the face of the disk. The display elements take the form of messages to be viewed individually through the window. A knob is preferably mounted at the outermost end of the shaft or stud, and adjacent the outer surface of the front panel. Rotating the knob rotates the disk and therefore changes the display element viewed through the window.

Further advantages and features of the present invention will be apparent from the following detailed description, taken in conjunction with the accompanying drawing, which illustrate, by way of example, the principles of the invention.

### BRIEF DESCRIPTION OF THE DRAWINGS

FIG. 1 is a front view of the preferred embodiment of the present invention, a variable display device.

FIG. 2 shows a second embodiment of the present invention.

FIG. 3 shows a cross section view of a portion of the second embodiment.

FIG. 4 shows a portion of the second embodiment.

FIG. 5 shows another portion of the second embodiment.

### DESCRIPTION OF THE PREFERRED EMBODIMENTS

In accordance with the present invention, a variable display device is disclosed. The device is directed to a simple, convenient and low-cost device used for selectively displaying messages on or adjacent a door. In particular, the device is most appropriate on or adjacent doors to hospital rooms, hotel and motel rooms, offices, conference rooms and the like to communicate such messages as “Do Not Disturb,” “Sleeping,” “In Conference,” “Occupied,” etc. The variable display device does not require electronic components or magnetic couplings, and is less complicated and costly and more convenient to install and deinstalll without the need for a hole through the door. In the broadest context, the variable display device of the present invention consists of components configured and correlated with respect to each other so as to attain the desired objective.

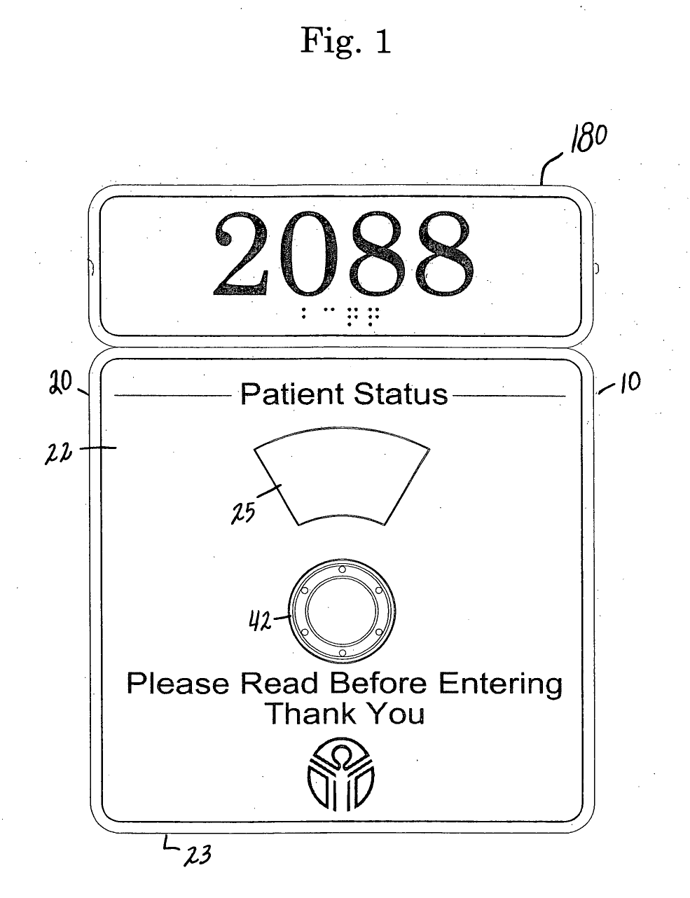

FIG. 1 illustrates a preferred embodiment of a variable display device 10 made in accordance with the present invention. The display device 10 generally comprising a frame member 20 with a window 25 defined in the approximate lower end thereof. As will be described, behind the window 25 is a display member coupled to the frame member 20. The display member is movable to change the message appearing in the window 25.

As will be understood, the variable display device 10 has many applications, the illustrated use being disclosed namely for use in a hospital, is merely by way of example. The variable display device 10 may be adapted for use not only in the hospital, but for hotels and motels, offices, conference rooms and the like.

The variable display device 10 includes front and back panels 22, 23, with the opening or window 25 formed in the front panel 22. The display device 10 is adapted to present various messages for view through the window 25. By attaching the back panel 23 of the display device 10 on or adjacent to a door or surface (not shown) by means known in the art such as screws, the displayed message may be selectively changed as appropriate. The changeable message seen through the window 25 may be adapted to cooperate with the application. For example, if installed on or adjacent to a hospital room door, the window 25 of the front panel 22 might display the message: “Sleeping,” or “Walking,” or “Eating,” for example. As shown, the face of the front panel 22 can further display various instructions such as the message: “Please Read Before Entering Thank You.” As shown, the front panel 22 preferably has a rectangular configuration however, as should be understood, other shapes and configurations can be employed.

Behind the window 25, and coupled to the front panel 22 is the display member which is movable to display the selected message in the window 25. As will be further described, the display member generally comprises a rotatable disk mounted to a shaft or stud adapted to pivot about an axis. In particular, the stud is rotatably attached to the back panel 23 and forwardly extends to the front panel 22. The rotatable disk is vertical and is rotatable about a horizontal axis.

Various display elements are carried on the face of the disk. As already discussed, the display elements take the form of messages to be viewed individually through the window 25.

A knob 42 is preferably mounted at the outermost end of the shaft of stud, and is disposed adjacent the outer surface of the front panel 22. Rotating the knob 42 likewise rotates the disk and therefore changes the display element viewed through the window 25. It is preferred that the knob 42 and stud not rotate freely but rotate with minimal friction so that once the selected message is positioned in the window 25, such message will remain displayed and not further rotate.

As shown in FIG. 1, except for the selected display element viewed through the window 25, the rotatable disk is completely hidden from view while it is rotating and being positioned by the knob 42.

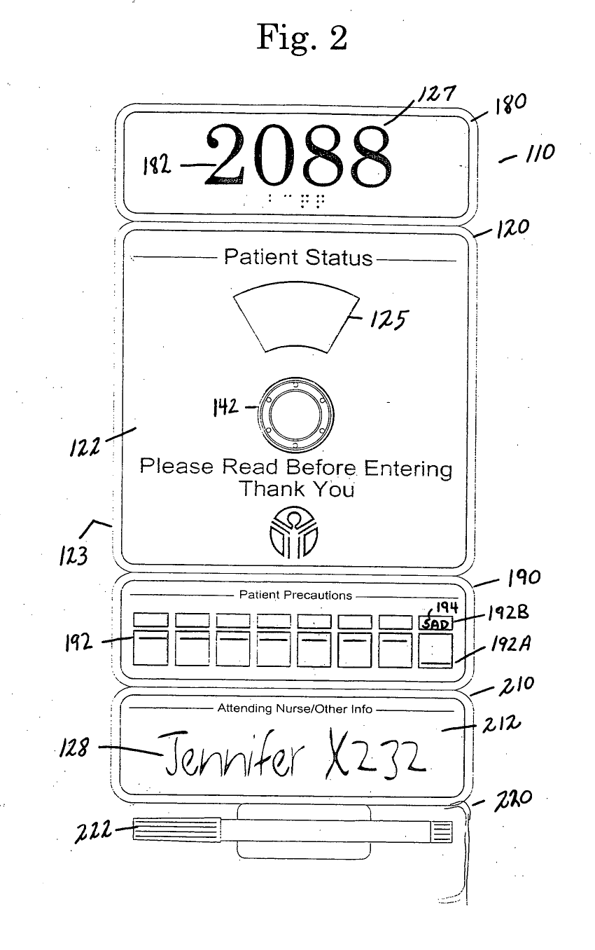

FIG. 2 illustrates a second embodiment, a variable display device 110 made in accordance with the present invention. The display device 110 generally comprising a frame member 120 with a window 125 defined in an upper portion thereof. As will be described, behind the window 125 is a display member 130 coupled to the frame member 120. The display member 130 is movable to change the message appearing in the window 125.

As will be understood, the variable display device 110 has many applications, the illustrated use being disclosed namely, for use in a hospital, is merely by way of example. The variable display device 110 may be adapted for use not only in the hospital, but for hotels and motels, offices, conference rooms and the like.

The variable display device 110 includes front and back panels 122, 123, with the opening or window 125 formed in the front panel 122. The display device 110 is adapted to present various messages for view through the window 125. By attaching the back panel 123 of the display device 110 on or adjacent to a door or surface (not shown) by means known in the art such as screws, the displayed message may be selectively changed as appropriate. The changeable messages seen through the window 125 may be adapted to cooperate with the application. For example, if installed on or adjacent to a hospital room door, the window 125 of the front panel 122 might display the message: “Sleeping,” or “Walking,” or “Eating,” or “Visitors” for example. As shown, the face of the front panel 122 can further show the patient's room number 127, the name of an attending nurse 128, and other such relevant information, for example. As shown, the front panel 122 preferably has a rectangular configuration however, as should be understood, other shapes and configurations can be employed.

Behind the window 125, and coupled to the front panel 122 is the rotatable disk display member 130 which is movable to display the selected message in the window 125. In particular, the rotatable disk display member 130 comprises a rotatable disk and knob 142, the knob 142 includes an inner tapered conical section 144 that rotatably rides on a hub 146 such as cooperating raised conical section 147 on the back panel 123. The rotatable disk display member 130 is vertical and is rotatable about a horizontal axis. The front panel 122, back panel 123, and display member are thin and can be formed from thin sheet of plastic by vacuum forming or thermo forming. The front panel 122 can be connected to the back panel 123 by adhesive or by sonic welding, for example, leaving the rotatable disk display member trapped between the front and back panels but rotatable about hub 146.

Rotating the knob 142 likewise rotates the disk 130 and therefore changes the display element viewed from the window 125. It is preferred that the knob 142 not rotate freely but rotate with minimal friction between the front and rear panels so that once the selected message is positioned in the window 125, such message will remain displayed and not further rotate even as the door (not shown) is opened and shut.

Except for the selected display element viewed through the window 125, the rotatable disk 130 is completely hidden from view while it is rotating and being positioned by the knob 142.

FIG. 2 shows that in addition to the frame member 120, there can also be other frames 180, 190, 210 and 220. Frame 180 can contain indicia such as a room number 182. Frame 190 can include a plurality of slider elements 192 (shown in the up position). Slider 192A is shown pulled down to reveal information 194 in window 192B. This can allow an attendant or nurse or on duty to place information on the door of a patient's room that would be visible to the hospital staff or visitors prior to entering the room. These sliders can be preprinted with typical precautions for a given industry such as schools or hospitals or they can be blank such that a user can fill in custom messages.

Frame 210 can include a writing space 212 and frame 220 can be designed to hold a marker 222 for use with the writing space.

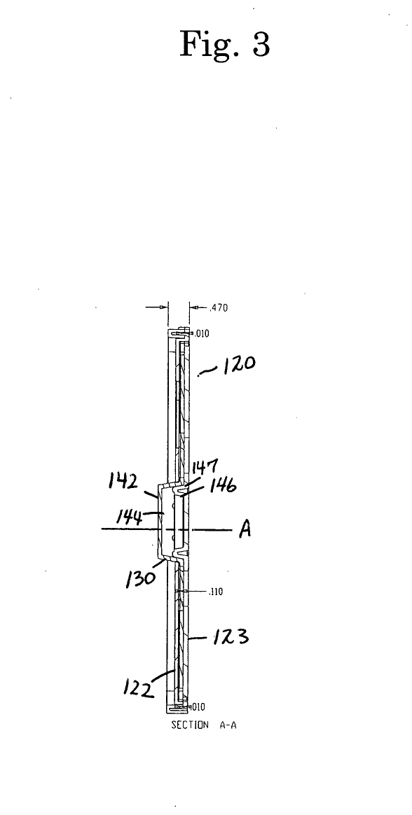

FIG. 3 shows a cross sectional view of the display 120, the front panel 122, rear panel 123 and rotatable portion 120 including knob 142. FIG. 3 also shows conical section hub 146 that centers rotatable disk display member 130 about axis “A” such that indicia will properly appear in window 125. The conical section is desirable in that it is easily released from a mold and that it is easy to assemble the rear panel, rotatable display portion 130 and front panel 122 as the conical sections cooperate to guide the assembly.

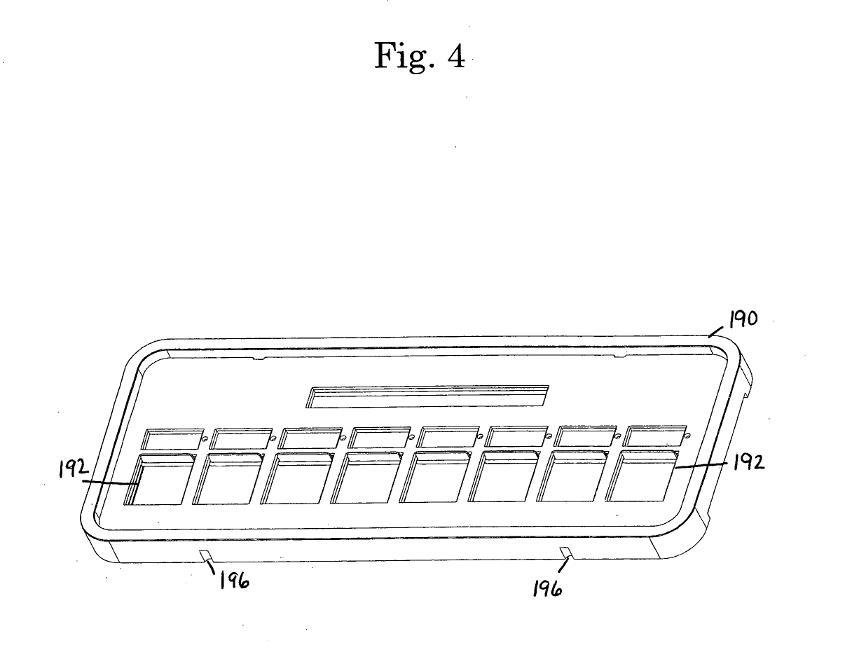

FIG. 4 shows frame 190 in perspective. In addition to sliders 192 the frame can include alignment pockets 196 that receive tabs (not shown) on the frame 210 below it. The pocket and tab arrangement can be included on each frame allowing them to be aligned on a door or surface.

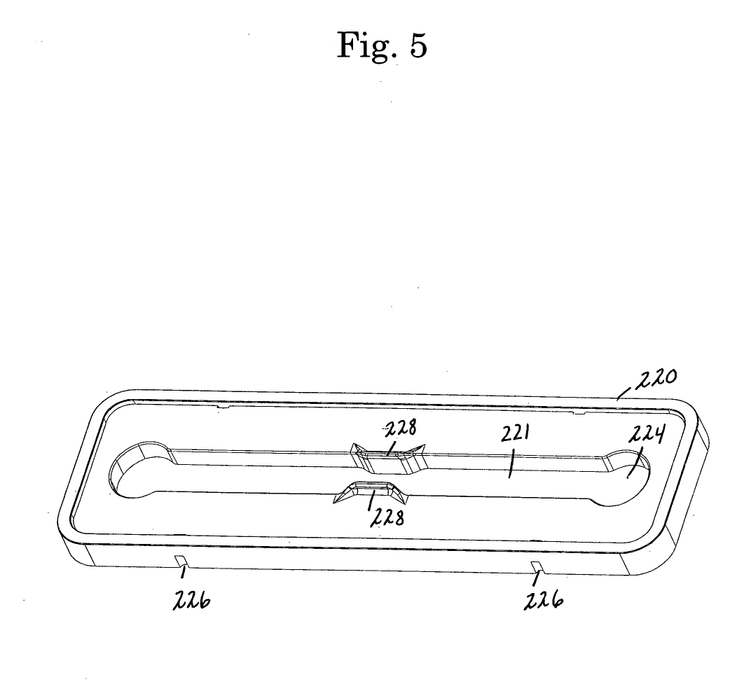

FIG. 5 shows details of the frame 220. The frame 220 includes an opening 221 sized to hold a marker 222. The frame 220 can include enlarged openings 224 to aid in removing a marker 222 from the grips 228 contained on each side of opening 221. Pockets 226 align with tabs (not shown) on any frame 120, 180, 190, 210 and 220 to allow the user to stack the frames in order, with the room number on the top (as shown) or on the bottom for example. The alignment pockets holding the frames aligned on the door while allowing the frames 120, 180, 190, 210 and 220 to be stacked upon each other in any order.

The present invention has many applications and is particularly useful in any situation where it is necessary to quickly and reliably provide a message on or adjacent a door to a room concerning the status of the person or persons inside that room.

It will be obvious to those skilled in the art that modifications may be made to the embodiments described above without departing from the scope of the invention. Thus the scope of the invention should be determined by the claims in the formal application and their legal equivalents, rather than by the examples given.

I claim:

1. A variable display device comprising:
a frame member mounted on a surface, said frame member including a window,
a display member rotatably coupled to the frame member,
a plurality of various display elements are carried on a face of the display member, wherein one of said display elements selectively appear in the window of the frame member,
rotating means coupled to the display member such that rotating the display member changes the display element viewed through the window

2. The variable display device as recited in claim 1, wherein the display element is a rotatable disk.

3. The variable display device as recited in claim 2, wherein the rotatable disk is mounted to a shaft or stud adapted to pivot about an axis.

4. The variable display device as recited in claim 1, wherein the display elements are messages to be viewed individually through the window.

5. The variable display device as recited in claim 3, further including a knob mounted at an outermost end of the shaft of stud, said knob is further adjacent an outer surface of the front member.

6. A display device comprising:
a first frame member mountable on a surface,
a display member rotatably coupled to the frame member,
a front panel covering at least a portion of said rotatable display member,
a rear panel behind said rotatable display and including a hub rotatably carrying said rotatable display member,
a window in said front panel revealing a portion of said rotatable display member, said portion including indicia,
wherein said indicia selectively appears in the window of the front panel as said rotatable display member is rotated.

7. The display as recited in claim 6, wherein friction between said rotatable display member and said front panel will hold said rotatable display member in a selected position.

8. The display as recited in claim 6, wherein said hub is integrally formed on said rear panel.

9. The display as recited in claim 8, wherein said hub is a conical section and wherein said rotatable display member includes a cooperating conical section that supports said rotatable display device on said hub for rotation.

10. The display device as recited in claim 6, including a writing surface and a marker to write on said surface held by grips on said display.

11. The display as recited in claim 6, wherein said first frame includes means to mount the frame to a surface and wherein said first frame includes alignment tabs to align said first frame with a second frame, said second frame including a writing surface such that a written message may be left adjacent said indicia.

12. A display device for use on a door comprising:
a first frame member mountable on said door, said frame member including a window,
a display member rotatably coupled to the first frame member,
a front panel covering at least a portion of said rotatable display member,
a rear panel behind said rotatable display and,
a window in said front panel revealing a portion of said rotatable display member, said portion including indicia,
wherein said indicia selectively appears in the window of the front panel as said rotatable display member is rotated and wherein friction between at least one of said front and rear panels and said rotatable member holds said rotatable display member in place such that said indicia is maintained in said window even as said door is moved.

13. The display as recited in claim 12, wherein one of said front and rear panel includes a hub rotatably mounting the rotatable display between said front and rear panels.

14. The display as recited in claim 13, wherein said hub is a conical section and wherein said rotatable display member includes a knob having a cooperating conical section that supports said rotatable display device on said hub for rotation.

15. The display as recited in claim 14, further including a second frame having a writing surface and a marker to write on said surface held by grips on a third frame.

16. The display as recited in claim 15, wherein said first, second, and third frames include alignment means, said alignment means holding said frames aligned on said door while allowing the first, second, and third frames to be stacked upon each other in any order.
